(19) United States
(12) Patent Application Publication
(10) Pub. No.: US 2014/0036402 A1
(43) Pub. Date: Feb. 6, 2014

(54) FIXING ELEMENT FOR PREVENTING ESD AND ELECTRONIC DEVICE USING THE SAME

(71) Applicant: Tse-Ming Tsai, New Taipei City (TW)

(72) Inventor: Tse-Ming Tsai, New Taipei City (TW)

(73) Assignees: Cal-Comp Electronics & Communications Company Limited, New Taipei City (TW); KINPO ELECTRONICS, INC., New Taipei City (TW)

(21) Appl. No.: 13/615,627

(22) Filed: Sep. 14, 2012

(30) Foreign Application Priority Data
Aug. 6, 2012 (TW) 101128291

(51) Int. Cl. H05F 3/02

(52) U.S. Cl. 361/220

(57) ABSTRACT

A fixing element for preventing electrostatic discharge (ESD) and an electronic device using the same are provided. The electronic device includes a substrate, an ESD shield, and a plurality of the fixing elements. The ESD shield disposed on the substrate has an assembling portion. Each of the fixing elements has a body portion, a fixing portion, and a cantilever portion. The body portion leans against the ESD shield and has a cutting opening. The fixing portion is disposed on the substrate and extends and bends from the body portion, wherein the fixing portion is perpendicular to the body portion. The cantilever portion is disposed in the cutting opening, wherein one end of the cantilever portion connects to the body portion and the other end is a free end. The cantilever portion passes through the assembling portion of the ESD shield.

### CROSS-REFERENCE TO RELATED APPLICATION

This application claims the priority benefit of Taiwan application serial no. 101128291, filed on Aug. 6, 2012. The entirety of the above-mentioned patent application is hereby incorporated by reference herein and made a part of this specification.

### BACKGROUND OF THE INVENTION

1. Field of the Invention

The invention relates to a fixing element for preventing electrostatic discharge (ESD) and an electronic device, and particularly relates to a fixing element having a simple structure and providing favorable fixing effect and an electronic device using the fixing element to fix a shield on a substrate.

2. Description of Related Art

General electronic products are usually light and handy and may be more sensitive to the interference of ESD. The conventional method is to add a shield outside the electronic parts to prevent ESD.

Usually, a metallic shield is placed on a substrate to directly cover the electronic parts, and the bottom edge of the shield is fixed to the substrate by welding.

Because the space between the electronic parts on the substrate is small, the welding process usually takes much time. Moreover, once the shield is fixed, it will be required to damage the shield in order to repair the parts covered by the shield, and the damaged shield is not reusable.

### SUMMARY OF THE INVENTION

The invention provides a fixing element with a simple structure and favorable fixing effect for preventing ESD.

The invention provides an electronic device, which utilizes the fixing element to fix a shield on a substrate and is easy to maintain or assemble.

The invention provides a fixing element for preventing ESD, and the fixing element includes a body portion, a fixing portion, a cantilever portion, wherein the body portion has a cutting opening, and the fixing portion is extended and bent from the body portion to be perpendicular to the body portion. The cantilever portion is disposed in the cutting opening, wherein an end of the cantilever portion connects to the body portion and the other end thereof is a free end.

The invention further provides an electronic device which includes a substrate, a shield, and a plurality of fixing elements. The substrate has multiple electronic units disposed thereon, and the shield is disposed on the substrate and covers one or many of the electronic units. The shield includes an assembling portion. Each of the fixing elements includes a body portion, a fixing portion, and a cantilever portion. The body portion leans against the shield and has a cutting opening. The fixing portion is disposed on the substrate and is extended and bent from the body portion to be perpendicular to the body portion. The cantilever portion is disposed in the cutting opening, wherein an end of the cantilever portion connects to the body portion and the other end thereof is a free end. The cantilever portion passes through the assembling portion of the shield.

Based on the above, the fixing element of the invention has the simple structure and can effectively fix the shield on the substrate. In addition, corresponding to the number of the shields, one fixing element may be used for the fixture of two ESD shields. More specifically, one fixing element may be disposed between two shields to simultaneously fix two shields.

To make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic view of an electronic device according to the first embodiment of the invention.

FIG. 2 is a schematic view of a shield of FIG. 1.

FIG. 3 is a schematic view of a fixing element of FIG. 1.

FIG. 4 is a schematic view of a fixing element according to the second embodiment of the invention.

FIG. 5 is a schematic view of the fixing elements of FIG. 3 and FIG. 4 used for fixing a plurality of shields.

### DESCRIPTION OF THE EMBODIMENTS

### First Embodiment

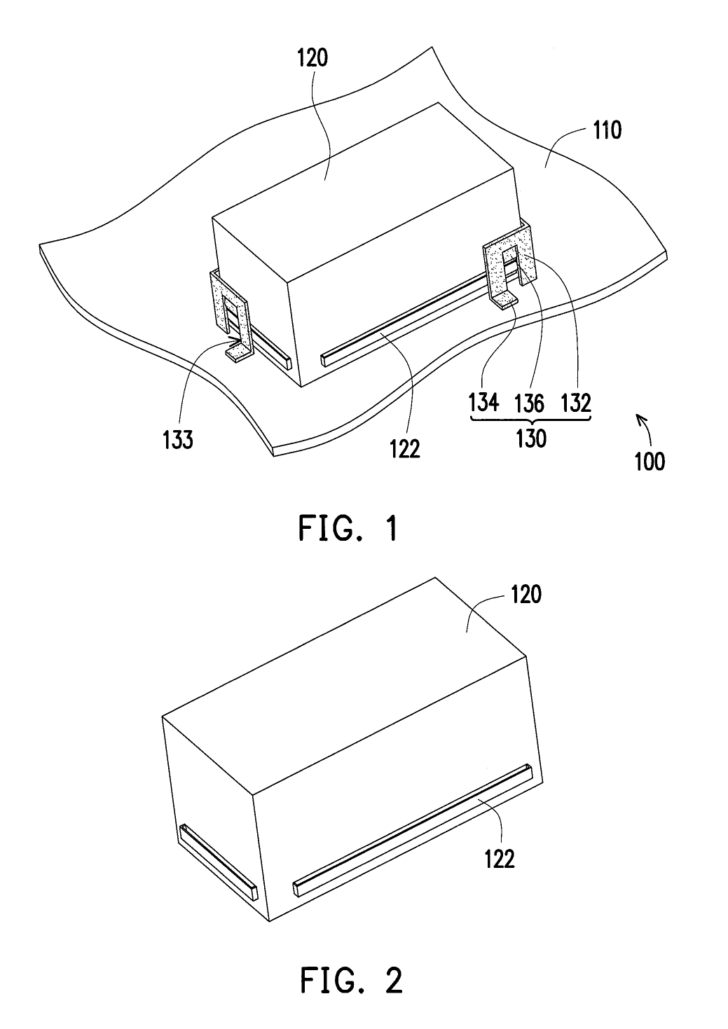

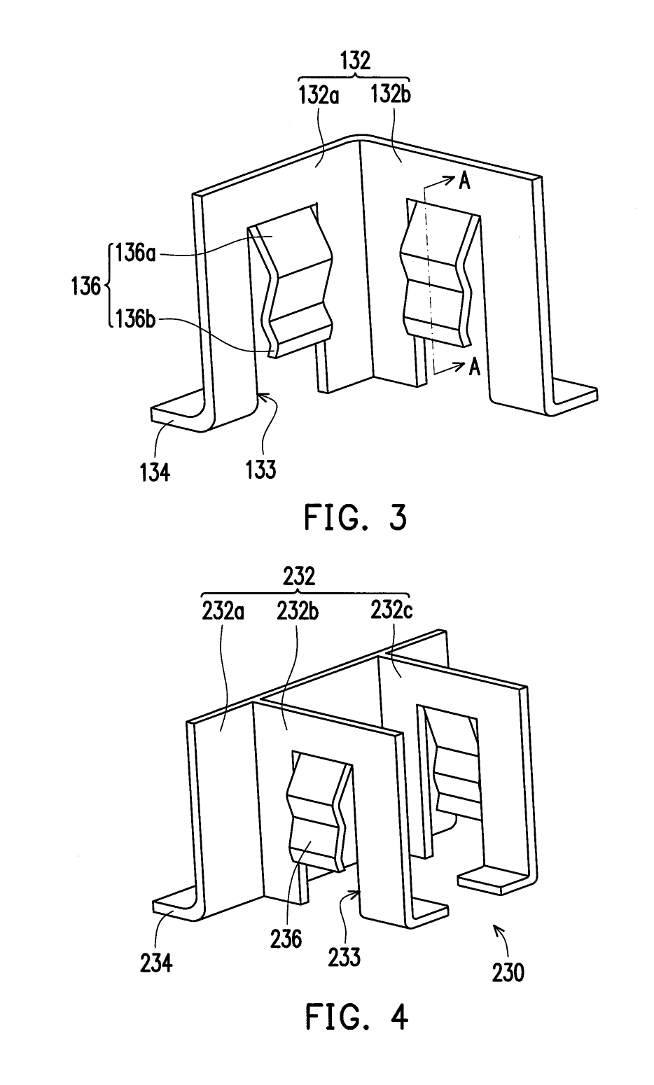

FIG. 1 is a schematic view of an electronic device according to the first embodiment of the invention. FIG. 2 is a schematic view of a shield of FIG. 1. FIG. 3 is a schematic view of a fixing element of FIG. 1. Referring to FIGS. 1-3 simultaneously, an electronic device 100 includes a substrate 110, a shield 120, and a plurality of fixing elements 130. The substrate 110 includes multiple electronic units (not shown), and the shield 120 is disposed on the substrate 110 and covers one or many of the electronic units. The shield 120 includes an assembling portion 122, wherein the assembling portion 122 is a groove. Each of the fixing elements 130 includes a body portion 132, a fixing portion 134, and a cantilever portion 136. The body portion 132 leans against the shield 120 and has a cutting opening 133. The fixing portion 134 is disposed on the substrate 110 and is extended and bent from the body portion 132 to be perpendicular to the body portion 132. The cantilever portion 136 is disposed in the cutting opening 133, wherein an end 136a of the cantilever portion 136 connects to the body portion 132 and the other end 136b thereof is a free end. The cantilever portion 136 passes through the assembling portion 122 of the shield 120.

To be more specific, the shield 120 is an ESD shield. The cutting opening 133 is formed by cutting the body portion 132 inward from an edge of the body portion 132, and the cut portion is bent to form the cantilever portion 136, wherein a cross-section of the cantilever portion 136 along the line A-A has an approximately jagged shape.

In addition, the body portion 132 includes a first region 132a and a second region 132b which are perpendicular to each other. Moreover, the first region 132a, the second region 132b, and the fixing portion 134 are perpendicular to each other respectively. Each of the first region 132a and the second region 132b includes one cutting opening 133, at least one fixing portion 134, and one cantilever portion 136.

When the electronic device 100 is assembled, the fixing element 130 and the shield 120 are first put together by aligning a joint of the first region 132a and the second region 132b with a corner of the shield 120 and keeping the first region 132a and the second region 132b of the fixing element 130 against the shield 120 to insert the cantilever portion 136 of the fixing element 130 into the assembling portion 122 of the shield 120 along an assembling direction. When the free end of the cantilever portion 136 contacts the assembling portion 122, the free end is pressed by the assembling portion 122 to deform the cantilever portion 136, and the shape of the cantilever portion 136 (approximately jagged shape) and the assembling portion 122 form a mechanism for guiding each other, so as to insert the cantilever portion 136 into the assembling portion 122. The flexibility of the cantilever portion 136 effectively assembles the fixing element 130 and the shield 120 close to each other.

Then, the fixing element 130 and the shield 120 are placed on the substrate 110, wherein the shield 120 covers one or many of the electronic units on the substrate 110 and the fixing portion 134 of the fixing element 130 leans against the substrate 110.

Thereafter, the substrate 110, the shield 120 placed on the substrate 110, and the fixing element 130 assembled with the shield 120 are put into a soldering pot. After heating and cooling processes, the fixing portion 134 of the fixing element 130 is fixed on the substrate 110 to fix the shield 120 onto the substrate 110.

It is known from the above that the fixing element 130 of this embodiment is located corresponding to the corner of the shield 120. Accordingly, one shield 120 can be fixed by disposing two fixing elements 130 at two diagonal corners of the shield 120 respectively, and the production costs are effectively reduced.

Moreover, the structure of the fixing element 130 is simple, easy to fabricate, and easy to assemble with the shield 120. Compared with the conventional assembly structure, the fixing element 130 of this embodiment saves time and effectively reduces production costs, and is applicable to modular production.

### Second Embodiment

This embodiment is approximately the same as the above embodiment, wherein identical or similar elements are denoted by identical or similar reference numerals. Description of the same elements will be omitted hereinafter, and only the differences will be explained below.

FIG. 4 is a schematic view of a fixing element according to the second embodiment of the invention. Referring to FIG. 4, the difference between this embodiment and the above embodiment lies in that: a body portion 232 of a fixing element 230 of this embodiment further includes a third region 232c, wherein the third region 232c is parallel to a second region 232b, a first region 232a is perpendicular to a fixing portion 234, the second region 232b is perpendicular to the fixing portion 234, and the third region 232c is also perpendicular to the fixing portion 234. Each of the second region 232b and the third region 232c includes a cutting opening 233 and a cantilever portion 236 respectively, and the first region 232a includes a plurality of fixing portions 234.

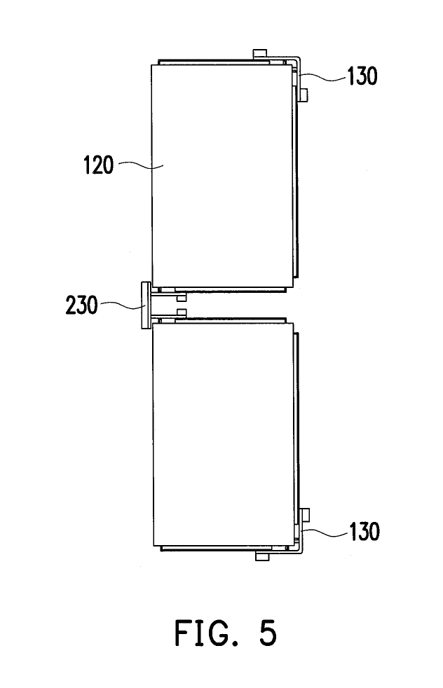

The structure of the fixing element 230 of this embodiment is slightly different from the structure of the fixing element 130 of the first embodiment. By using the fixing element 230 of this embodiment together with the fixing elements 130 of the first embodiment, it only takes three fixing elements to fix two adjacent shields 120, as shown in FIG. 5.

It is known from the above two embodiments that the fixing elements 130 and 230 may be coordinated and used together for disposing various numbers of the shields 120 in different electronic devices.

In conclusion of the above, the fixing element of the invention has the advantages of simple structure, being easy to fabricate, and easy to assemble with the shield, which not only saves time and effectively reduces costs but also facilitates maintenance.

In addition, one shield can be fixed by disposing two fixing elements at two diagonal corners of the shield respectively; and the fixing elements of the above two embodiments can be used together to fix adjacent shields. Accordingly, the production costs are effectively reduced.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A fixing element adapted for preventing electrostatic discharge (ESD), comprising:
a body portion comprising a cutting opening;
a fixing portion extended and bent from the body portion to be perpendicular to the body portion; and
a cantilever portion disposed in the cutting opening, wherein an end of the cantilever portion connects to the body portion and the other end thereof is a free end.

2. The fixing element according to claim 1, wherein the cutting opening is formed by cutting the body portion inward from an edge of the body portion.

3. The fixing element according to claim 2, wherein the cantilever portion is formed by bending a portion that is formed by cutting the body portion inward from the edge of the body portion.

4. The fixing element according to claim 1, wherein the body portion comprises a first region and a second region, and the first region and the second region are perpendicular to each other.

5. The fixing element according to claim 4, wherein the first region, the second region, and the fixing portion are respectively perpendicular to each other.

6. The fixing element according to claim 5, wherein each of the first region and the second region comprises one cutting opening, at least one fixing portion, and one cantilever portion.

7. The fixing element according to claim 4, wherein the body portion further comprises a third region, and the third region is parallel to the second region and perpendicular to the first region.

8. The fixing element according to claim 7, wherein the first region is perpendicular to the fixing portion, the second region is perpendicular to the fixing portion, and the third region is perpendicular to the fixing portion.

9. The fixing element according to claim 7, wherein each of the second region and the third region comprises one cutting opening and one cantilever portion, and the first region comprises a plurality of the fixing portions.

10. An electronic device, comprising:
a substrate comprising electronic units;
a shield disposed on the substrate, covering a portion of the electronic units, and comprising an assembling portion;
a plurality of fixing elements for preventing ESD, wherein each of the fixing elements comprises:
a body portion leaning against the shield and comprising a cutting opening;
a fixing portion extended and bent from the body portion to be perpendicular to the body portion and disposed on the substrate; and
a cantilever portion disposed in the cutting opening, wherein an end of the cantilever portion connects to the body portion and the other end thereof is a free end, and the cantilever portion passes through the assembling portion of the shield.

11. The electronic device according to claim 10, wherein the cutting opening is formed by cutting the body portion inward from an edge of the body portion.

12. The electronic device according to claim 11, wherein the cantilever portion is formed by bending a portion that is formed by cutting the body portion inward from the edge of the body portion.

13. The electronic device according to claim 10, wherein the body portion comprises a first region and a second region, and the first region and the second region are perpendicular to each other.

14. The electronic device according to claim 13, wherein the first region, the second region, and the fixing portion are respectively perpendicular to each other.

15. The electronic device according to claim 14, wherein each of the first region and the second region comprises one cutting opening, at least one fixing portion, and one cantilever portion.

16. The electronic device according to claim 13, wherein the body portion further comprises a third region, and the third region is parallel to the second region.

17. The electronic device according to claim 16, wherein the first region is perpendicular to the fixing portion, the second region is perpendicular to the fixing portion, and the third region is perpendicular to the fixing portion.

18. The electronic device according to claim 16, wherein each of the second region and the third region comprises one cutting opening and one cantilever portion, and the first region comprises a plurality of the fixing portions.
